(19) United States
(12) Patent Application Publication
(10) Pub. No.: US 2005/0153046 A1
(43) Pub. Date: Jul. 14, 2005

(54) Pourable liquid dairy dessert

(76) Inventor: Mark Robert, Fairbury, IL (US)

Correspondence Address: Monique A. Morneault, Esq.;Wallenstein Wagner & Rockey, Ltd., 53rd Floor, 311 South Wacker Drive, Chicago, IL, 60606-6630, US

(21) Appl. No.: 10/754,242

(22) Filed: Jan. 9, 2004

(51) Int. Cl. A23L 1/05

(52) U.S. Cl. 426/573

(57) ABSTRACT

A pourable dessert product, prepared without an emulsifier, comprising milk solids nonfat, fat, sweetener, stabilizer and flavoring agent.

### TECHNICAL FIELD

The invention is an improved pourable dairy dessert product.

### BACKGROUND OF THE INVENTION

Dessert mixes, and particularly those from dairy ingredients, are well known and used both by the average consumer and in the commercial food industry. One such traditional dessert includes a cake soaked with a dairy mix made from a combination of three milks, known as “tres leches.” The customary way of preparing the tres leches mix is through the blending of three milk products: whole milk, sweetened condensed milk and evaporated milk. Given the required freshness of the product, preparing and storing the traditional tres leches mix to maintain its integrity, is a challenge to commercial-scale food producers and suppliers.

One such commercial product is described in U.S. Pat. No. 6,197,362, and its continuation, now U.S. Pat. No. 6,569,485, both to Hussein, and assigned to Rich Products Corporation. The '362 patent and the '485 patent both describe a pourable liquid dessert product comprising a protein source, fat, sweetener, stabilizer, flavoring agent and emulsifier. Both patents state that “[i]t is yet another object of this invention to provide a single pourable dessert liquid product which may be either dairy or non-dairy, is freezable, is consistent in quality and overall improves the sanitary and keeping quality since only a single liquid is used with no exposure to contamination as in the case of mixing three separate milks.” (Col. 1, lines 41-47).

Both patents describe and claim the following ingredients: protein or protein source, fat, sweetener, stabilizer, flavoring agent and emulsifier. There is no teaching or suggestion in either patent that any of these ingredients can be omitted. Further, the “dairy protein source” listed in the patents include dried skim milk, whey protein, and milk protein concentrate. There is no teaching or suggestion that the dairy protein source includes whole milk, evaporated milk, or cream as in the original tres leches formula.

However, it has been discovered it is possible to produce on a commercial scale, a dairy-based pourable dessert topping without an emulsifier. The present invention is an improved pourable dairy dessert product, maintaining the taste, texture and integrity of the original dairy-based tres leches product. Even in the absence of an emulsifier, the present product can be frozen and thawed for use, while maintaining the desired characteristics of taste, texture, and soaking ability required of products of this nature.

Accordingly, there is a need for an improved pourable dairy-based dessert product, having taste and texture more authentic to the original “three milk” tres leches product, and prepared without an emulsifier.

### SUMMARY OF THE INVENTION

According to one aspect of the invention, a pourable dessert product is provided. The dessert product comprises about 4.50-15.0 weight % milk solids nonfat; about 1.0-15.0 weight % fat; about 10.0-25.0 weight % sweetener; about 0.10-0.30 weight % stabilizer and about 0.1-2.0 weight % flavoring agents.

In another aspect of the invention, a liquid dairy mix composition without an emulsifier, is provided. The liquid mix composition comprises about 4.50-15.00% milk solids nonfat; about 1.0-15.0 weight % fat; about 10.0-25.0 weight % sweetener; about 0.10-0.30 weight % stabilizer and about 0.1-2.0 weight % flavoring agents.

### DETAILED DESCRIPTION

There are many possible embodiments of this invention. The description below describes in detail a preferred embodiment of the invention. It should be understood that the present disclosure is to be considered as an example of the principles of the invention. The disclosure is not intended to limit the broad aspect of the invention to the embodiments illustrated.

The present invention is directed to a dairy-based, pourable dessert product, and more specifically, a liquid mix for creation of the cake known as “tres leches.” The pourable dessert product is made up of fat, milk solids nonfat, sweetener, stabilizer and flavoring agent, but eliminates the need for an emulsifier.

The amount of milk solids nonfat in the dessert product should be about 4.50-15.00 weight %, and preferably about 8.5 weight %. Examples of suitable sources of milk solids nonfat include cream, milk, whey powder, condensed skim milk, sweetened condensed milk, whole milk powder, evaporated milk, nonfat dry milk, or buttermilk powder. The preferred dairy sources are milk, nonfat dry milk, condensed skim milk, cream, and whey powder.

The amount of fat in the dessert product should be about 1.0-15.0 weight %, preferably about 6.0 weight %. The origin of the fat is also dairy fat, with butterfat being the preferred ingredient in the composition. Potential sources of butterfat include cream, milk, whole milk powder, evaporated milk, and sweetened condensed milk, with cream and milk being the preferred sources.

The amount of sweetener should be about 10-25 weight %, preferably about 15.5 weight %. Examples of sweeteners include corn syrup, sucrose, fructose, high fructose corn syrup, dextrose, maltodextrin, invert sugar, lactose, maltitol, or sorbitol. Preferred sweeteners include sucrose and corn syrup.

The amount of stabilizer should be about 0.1-0.3 weight %, preferably 0.20 weight %. Examples of stabilizers include carageenan, guar gum, locust bean gum, xanthum gum, cellulose, modified cellulose and hydrocolloids. Preferred stabilizers include carrageenan and carboxymethyl cellulose.

The amount of flavoring agent should be about 0.1-2.0 weight %, preferably about 0.6 weight %. Examples of flavoring agents include conventional flavoring agents such as caramel, vanilla, kahlua, coffee, mocha, raspberry, strawberry, citrus fruits, and liqueur flavor. A preferred flavoring is caramel.

It is contemplated that the pourable liquid dessert of the present invention will be used in the creation of a “tres leches” cake. The tres leches cake is traditionally created using a sponge type cake, over which the liquid mix is poured and thus allowed to soak into but not completely through the cake. Therefore, to achieve the flavor, texture and soaking characteristics required of the tres leches mix, the present formulation is, like the traditional mixture, a dairy-based mixture. The present formulation also does not require an emulsifier, an ingredient required in many non-dairy based mixtures made with non-dairy ingredients, such as vegetable oil.

The dessert product may be manufactured and/or packaged in group or single portions. The dessert product may be frozen, stored, distributed, and thawed for subsequent use and consumption.

The dessert product may be prepared by conventional methods, including regular pasteurization (LTLT, HTST), Extended Shelf Life (ESL), Ultra High Temperature (UHT) and in-container sterilization.

In one embodiment, the liquid dessert mix is prepared as a liquid mixture. Corn syrup, sucrose syrup and milk are added to a blending vat, and blended using a liquefier at high speed. Powdered ingredients, such as nonfat dry milk, whey powder, and other ingredients, including stabilizer, salt, flavoring and coloring are dispersed into the liquid. Once the powders are completely blended into the milk-sugar mixture, the mixture is transferred into a holding vat. The remaining sucrose syrup, milk and cream are surged through the blending vat to the holding vat. The entire batch is agitated on medium speed for five minutes to ensure a uniform mixture. The mixture is pasturized in an HTST pasteurizer by heating the mix to 178 F to 182 F for 25-35 seconds. Homogenization is performed at pressures between 200 and 5000 psig, with about 1500 psig being preferred, to prevent fat from agglomerating, coagulating or separating. The mixture is cooled using the cooling section of the homogenizer unit from the pasteurization temperature of 178 F-182 F to 35 F-40 F over a time period of 30-60 seconds. The resulting mixture can be frozen, stored, distributed and thawed, while maintaining the ideal characteristics of a pourable liquid texture and blended consistency with adequate soak times.

Nonlimiting examples of the invention are provided below. Example 1 is of the preferred embodiment.

### EXAMPLE 1

### Formulation of Dairy Pourable Dessert Products

### Batch Size: 1000 gallons (9148 lbs)

| | | Required | Weight % |
|---|---|---|---|
| Ingredients | | Amount (lbs) | (solids basis) |
| Cream | 40% butterfat | 858.00 | 6.0% butterfat |
| | 5.6% msnf | | |
| Milk | 3.5% butterfat | 5875.00 | |
| | 8.6% msnf | | |
| Nonfat Dry Milk | 0.3% butterfat | 43.00 | 6.5% msnf |
| | 96.0% msnf | | |
| Liquid Sucrose | 67.5% solids | 1863.00 | 13.75 |
| Corn Syrup, 42 DE | 80.3% solids | 199.00 | 1.75 |
| Whey Powder | | 200.00 | 2.09 |
| Stabilizer 8514-500 | | 22.86 | 0.25 |
| Sodium Acid | | 4.57 | 0.05 |
| Pyrophosphate | | | |
| Salt | | 18.30 | 0.20 |
| Caramel | 70.5% solids | 54.00 | 0.60 |
| Caramel Flavor | | 9.97 | 0.07 |
| Butterscotch Flavor | | 3.66 | 0.07 |
| Annatto Color | | 0.27 | 0.003 |
| Caramel Color | | 0.27 | 0.003 |

### EXAMPLE 2

### Highest Protein Level

### Formulation of Dairy Pourable Dessert Products

### Batch Size: 1000 gallons (9388 lbs)

| | | Required | Weight % |
|---|---|---|---|
| Ingredients | | Amount (lbs) | (solids basis) |
| Cream | 40% butterfat | 940.00 | 6.0% butter fat |
| | 5.6% msnf | | |
| Milk | 3.5% butterfat | 5275.00 | |
| | 8.6% msnf | | |
| Nonfat Dry Milk | 0.3% butterfat | 939.50 | 15.0% msnf |
| | 96.0% msnf | | |
| Liquid Sucrose | 67.5% solids | 1912.00 | 13.75 |
| Corn Syrup, 42 DE | 80.3% solids | 204.50 | 1.75 |
| Whey Powder | | — | — |
| Stabilizer 8514-500 | | 23.47 | 0.25 |
| Sodium Acid | | 4.69 | 0.05 |
| Pyrophosphate | | | |
| Salt | | 18.78 | 0.20 |
| Caramel | 70.5% solids | 55.40 | 0.60 |
| Caramel Flavor | | 10.23 | 0.07 |
| Butterscotch Flavor | | 3.76 | 0.07 |
| Annatto Color | | 0.28 | 0.003 |
| Caramel Color | | 0.28 | 0.003 |

### EXAMPLE 3

### Highest Fat Level

### Formulation of Dairy Pourable Dessert Products

### Batch Size: 1000 gallons (9044 lbs)

| | | Required | Weight % |
|---|---|---|---|
| Ingredients | | Amount (lbs) | (solids basis) |
| Cream | 40% butterfat | 3070.50 | 15.0% butterfat |
| | 5.6% msnf | | |
| Milk | 3.5% butterfat | 3655.20 | |
| | 8.6% msnf | | |
| Nonfat Dry Milk | 0.3% butterfat | 166.5 | 7.15% msnf |
| | 96.0% msnf | | |
| Liquid Sucrose | 67.5% solids | 1842.00 | 13.75 |
| Corn Syrup, 42 DE | 80.3% solids | 197.00 | 1.75 |
| Whey Powder | | — | — |
| Stabilizer 8514-500 | | 22.61 | 0.25 |
| Sodium Acid | | 4.52 | 0.05 |
| Pyrophosphate | | | |
| Salt | | 18.09 | 0.20 |
| Caramel | 70.5% solids | 53.36 | 0.60 |
| Caramel Flavor | | 9.86 | 0.07 |
| Butterscotch Flavor | | 3.62 | 0.07 |
| Annatto Color | | 0.27 | 0.003 |
| Caramel Color | | 0.27 | 0.003 |

### EXAMPLE 4

### Lowest Protein

### Formulation of Dairy Pourable Dessert Products

### Batch Size: 1000 gallons (8995 lbs)

| | | Required | Weight % |
|---|---|---|---|
| Ingredients | | Amount (lbs) | (solids basis) |
| Cream | 40% butterfat | 994.00 | 6.0% butterfat |
| | 5.6% msnf | | |
| Milk | 3.5% butterfat | 4059.00 | 4.5% msnf |
| | 8.6% msnf | | |
| Water | | 1801.30 | |
| Liquid Sucrose | 67.5% solids | 1832.00 | 13.75 |
| Corn Syrup, 42 DE | 80.3% solids | 196.00 | 1.75 |
| Whey Powder | | — | — |
| Stabilizer 8514-500 | | 22.49 | 0.25 |
| Sodium Acid | | 4.50 | 0.05 |
| Pyrophosphate | | | |
| Salt | | 17.99 | 0.20 |
| Caramel | 70.5% solids | 53.10 | 0.60 |
| Caramel Flavor | | 9.80 | 0.07 |
| Butterscotch Flavor | | 3.60 | 0.07 |
| Annatto Color | | 0.27 | 0.003 |
| Caramel Color | | 0.27 | 0.003 |

### EXAMPLE 5

### Lowest Fat

### Formulation of Dairy Pourable Dessert Products

### Batch Size: 1000 gallons (9117 lbs)

| | | Required | Weight % |
|---|---|---|---|
| Ingredients | | Amount (lbs) | (solids basis) |
| Milk | 3.5% butterfat | 2566.40 | 1.0% butterfat |
| | 8.6% msnf | | |
| Nonfat Dry Milk | 0.3% butterfat | 449.00 | 7.15% msnf |
| | 96.0% msnf | | |
| Water | | 3932.3 | |
| Liquid Sucrose | 67.5% solids | 1857.00 | 13.75 |
| Corn Syrup, 42 DE | 80.3% solids | 199.00 | 1.75 |
| Whey Powder | | — | — |
| Stabilizer 8514-500 | | 22.79 | 0.25 |
| Sodium Acid | | 4.56 | 0.05 |
| Pyrophosphate | | | |
| Salt | | 18.23 | 0.20 |
| Caramel | 70.5% solids | 53.80 | 0.60 |
| Caramel Flavor | | 9.94 | 0.07 |
| Butterscotch Flavor | | 3.65 | 0.07 |
| Annatto Color | | 0.27 | 0.003 |
| Caramel Color | | 0.27 | 0.003 |

### EXAMPLE 6

### Lowest Sugars

### Formulation of Dairy Pourable Dessert Products

### Batch Size: 1000 gallons (8899 lbs)

| | | Required | Weight % |
|---|---|---|---|
| Ingredients | | Amount (lbs) | (solids basis) |
| Cream | 40% butterfat | 745.00 | 6.0% butterfat |
| | 5.6% msnf | | |
| Milk | 3.5% butterfat | 6741.20 | |
| | 8.6% msnf | | |
| Nonfat Dry Milk | 0.3% butterfat | 15.46 | 7.15% msnf |
| | 96.0% msnf | | |
| Liquid Sucrose | 67.5% solids | 1121.00 | 8.50 |
| Corn Syrup, 42 DE | 80.3% solids | 166.00 | 1.50 |
| Whey Powder | | — | — |
| Stabilizer 8514-500 | | 22.25 | 0.25 |
| Sodium Acid | | 4.45 | 0.05 |
| Pyrophosphate | | | |
| Salt | | 17.80 | 0.20 |
| Caramel | 70.5% solids | 52.51 | 0.60 |
| Caramel Flavor | | 9.70 | 0.07 |
| Butterscotch Flavor | | 3.56 | 0.07 |
| Annatto Color | | 0.27 | 0.003 |
| Caramel Color | | 0.27 | 0.003 |

### EXAMPLE 7

### Highest Sugars

### Formulation of Dairy Pourable Dessert Products

### Batch Size: 1000 gallons (9458 lbs)

| | | Required | Weight % |
|---|---|---|---|
| Ingredients | | Amount (lbs) | (solids basis) |
| Cream | 40% butterfat | 1004.00 | 6.0% butterfat |
| | 5.6% msnf | | |
| Milk | 3.5% butterfat | 4722.4 | |
| | 8.6% msnf | | |
| Nonfat Dry Milk | 0.3% butterfat | 222.84 | 7.15% msnf |
| | 96.0% msnf | | |
| Liquid Sucrose | 67.5% solids | 2802.50 | 20.00 |
| Corn Syrup, 42 DE | 80.3% solids | 589.00 | 5.00 |
| Whey Powder | | — | — |
| Stabilizer 8514-500 | | 23.65 | 0.25 |
| Sodium Acid | | 4.73 | 0.05 |
| Pyrophosphate | | | |
| Salt | | 18.92 | 0.20 |
| Caramel | 70.5% solids | 55.80 | 0.60 |
| Caramel Flavor | | 10.31 | 0.07 |
| Butterscotch Flavor | | 3.78 | 0.07 |
| Annatto Color | | 0.28 | 0.003 |
| Caramel Color | | 0.28 | 0.003 |

### EXAMPLE 8

### Lowest Stabilizer

### Formulation of Dairy Pourable Dessert Products

### Batch Size: 1000 gallons (9091 lbs)

| | | Required | Weight % |
|---|---|---|---|
| Ingredients | | Amount (lbs) | (solids basis) |
| Cream | 40% butterfat | 836.60 | 6.0% butterfat |
| | 5.6% msnf | | |
| Milk | 3.5% butterfat | 6015.40 | |
| | 8.6% msnf | | |
| Nonfat Dry Milk | 0.3% butterfat | 89.40 | 7.15% msnf |
| | 96.0% msnf | | |
| Liquid Sucrose | 67.5% solids | 1851.80 | 13.75 |
| Corn Syrup, 42 DE | 80.3% solids | 198.10 | 1.75 |
| Whey Powder | | — | — |
| Stabilizer 8514-500 | | 9.09 | 0.10 |
| Sodium Acid | | 4.55 | 0.05 |
| Pyrophosphate | | | |
| Salt | | 18.18 | 0.20 |
| Caramel | 70.5% solids | 53.64 | 0.60 |
| Caramel Flavor | | 9.91 | 0.07 |
| Butterscotch Flavor | | 3.64 | 0.07 |
| Annatto Color | | 0.27 | 0.003 |
| Caramel Color | | 0.27 | 0.003 |

### EXAMPLE 9

### Highest Stabilizer

### Formulation of Dairy Pourable Dessert Products

### Batch Size: 1000 gallons (9098 lbs)

| | | Required | Weight % |
|---|---|---|---|
| Ingredients | | Amount (lbs) | (solids basis) |
| Cream | 40% butterfat | 839.20 | 6.0% butterfat |
| | 5.6% msnf | | |
| Milk | 3.5% butterfat | 5998.30 | |
| | 8.6% msnf | | |
| Nonfat Dry Milk | 0.3% butterfat | 91.30 | 7.15% msnf |
| | 96.0% msnf | | |
| Liquid Sucrose | 67.5% solids | 1853.30 | 13.75 |
| Corn Syrup, 42 DE | 80.3% solids | 198.25 | 1.75 |
| Whey Powder | | — | — |
| Stabilizer 8514-500 | | 27.29 | 0.30 |
| Sodium Acid | | 4.55 | 0.05 |
| Pyrophosphate | | | |
| Salt | | 18.20 | 0.20 |
| Caramel | 70.5% solids | 53.68 | 0.60 |
| Caramel Flavor | | 9.92 | 0.07 |
| Butterscotch Flavor | | 3.64 | 0.07 |
| Annatto Color | | 0.27 | 0.003 |
| Caramel Color | | 0.27 | 0.003 |

### EXAMPLE 10

### Lowest Flavor

### Formulation of Dairy Pourable Dessert Products

### Batch Size: 1000 gallons (9079 lbs)

| | | Required | Weight % |
|---|---|---|---|
| Ingredients | | Amount (lbs) | (solids basis) |
| Cream | 40% butterfat | 830.90 | 6.0% butterfat |
| | 5.6% msnf | | |
| Milk | 3.5% butterfat | 6061.40 | |
| | 8.6% msnf | | |
| Nonfat Dry Milk | 0.3% butterfat | 84.75 | 7.15% msnf |
| | 96.0% msnf | | |
| Liquid Sucrose | 67.5% solids | 1849.50 | 13.75 |
| Corn Syrup, 42 DE | 80.3% solids | 197.84 | 1.75 |
| Whey Powder | | — | — |
| Stabilizer 8514-500 | | 22.70 | 0.25 |
| Sodium Acid | | 4.54 | 0.05 |
| Pyrophosphate | | | |
| Salt | | 18.16 | 0.20 |
| Caramel | 70.5% solids | — | — |
| Caramel Flavor | | 9.08 | 0.10 |
| Butterscotch Flavor | | — | — |
| Annatto Color | | 0.27 | 0.003 |
| Caramel Color | | 0.27 | 0.003 |

### EXAMPLE 11

### Highest Flavor

### Formulation of Dairy Pourable Dessert Products

### Batch Size: 1000 gallons (9127 lbs)

| | | Required | Weight % |
|---|---|---|---|
| Ingredients | | Amount (lbs) | (solids basis) |
| Cream | 40% butterfat | 853.30 | 6.0% butterfat |
| | 5.6% msnf | | |
| Milk | 3.5% butterfat | 5885.50 | |
| | 8.6% msnf | | |
| Nonfat Dry Milk | 0.3% butterfat | 102.75 | 7.15% msnf |
| | 96.0% msnf | | |
| Liquid Sucrose | 67.5% solids | 1859.20 | 13.75 |
| Corn Syrup, 42 DE | 80.3% solids | 198.90 | 1.75 |
| Whey Powder | | — | — |
| Stabilizer 8514-500 | | 22.82 | 0.10 |
| Sodium Acid | | 4.56 | 0.05 |
| Pyrophosphate | | | |
| Salt | | 18.25 | 0.20 |
| Caramel | 70.5% solids | 181.25 | 1.40 |
| Caramel Flavor | | — | — |
| Butterscotch Flavor | | — | — |
| Annatto Color | | 0.27 | 0.003 |
| Caramel Color | | 0.27 | 0.003 |

Required Equipment
HTST Pasteurizer
Homogenizer
1000 gallon holding vat, with agitation
500 gallon blending vat with high speed agitation (liquefier)

1. A pourable dessert product comprising about 4.5-15.0 weight % milk solids nonfat; about 1.0-15.0 weight % fat; about 10.0-25.0 weight % sweetener; about 0.10-0.30 weight % stabilizer and about 0.1-2.0 weight % flavoring agents.

2. The dessert product of claim 1, wherein the milk solids nonfat source comprises cream, milk, whey powder, condensed skim milk, sweetened condensed milk, whole milk powder, nonfat dry milk, evaporated milk, or buttermilk powder.

3. The dessert product of claim 1, wherein the fat comprises butterfat.

4. The dessert product of claim 3, wherein the fat is selected from the group consisting of cream, milk, whole milk powder, evaporated milk, and sweetened condensed milk, with cream and milk being the preferred sources.

5. The dessert product of claim 1, wherein the sweetener comprises sucrose, corn syrup or both.

6. The dessert product of claim 1, wherein the sweetener is selected from the group consisting of corn syrup, sucrose, fructose, high fructose corn syrup, dextrose, maltodextrin, invert sugar, lactose, maltitol, or sorbitol.

7. The dessert product of claim 1, wherein the stabilizer is selected from the group consisting of carageenan, guar gum, locust bean gum, xanthum gum, cellulose, modified cellulose and hydrocolloids.

8. The dessert product of claim 1, wherein the product is a tres leches dairy mix.

9. The dessert product of claim 1, wherein the product is a cake soaking mix.

10. A liquid dairy mix composition absent the presence of an emulsifier, the composition comprising about 4.5-15.0 weight % milk solids nonfat; about 1.0-15.0 weight % fat; about 10.0-25.0 weight % sweetener; about 0.10-0.30 weight % stabilizer and about 0.1-2.0 weight % flavoring agents.

11. The dairy mix of claim 10, wherein the milk solids nonfat comprises cream, milk, whey powder, condensed skim milk, sweetened condensed milk, whole milk powder, nonfat dry milk, evaporated milk, or buttermilk powder.

12. The dairy mix of claim 10, wherein the fat comprises butterfat.

13. The dairy mix of claim 12 wherein the fat is selected from the group consisting of cream, milk, whole milk powder, evaporated milk, and sweetened condensed milk.

14. The dairy mix of claim 10, wherein the sweetener is selected from the group consisting of corn syrup, sucrose, fructose, high fructose corn syrup, dextrose, maltodextrin, invert sugar, lactose, maltitol, or sorbitol.

15. The dairy mix of claim 10, wherein the sweetener comprises corn syrup, sucrose or both.

16. The dairy mix of claim 10, wherein the stabilizer is selected from the group consisting of carageenan, guar gum, locust bean gum, xanthum gum, cellulose, modified cellulose and hydrocolloids.

17. The dairy mix of claim 10, wherein the mix is a liquid tres leches mix.

18. The dairy mix of claim 10, wherein the mix is a cake soaking mix.
